(19) United States
(12) Patent Application Publication
(10) Pub. No.: US 2008/0072193 A1
(43) Pub. Date: Mar. 20, 2008

(54) APPARATUS AND METHOD OF EXPRESSING CIRCUIT VERSION IDENTIFICATION

(75) Inventor: Shih-Pin Hsu, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/752,306

(22) Filed: May 23, 2007

(30) Foreign Application Priority Data
Sep. 18, 2006 (TW) 95134410

(51) Int. Cl. G06F 17/50

(52) U.S. Cl. 716/5

(57) ABSTRACT

An apparatus and a method of expressing circuit version identification (VID) are disclosed. The apparatus includes a plurality of conductive layers and a circuit VID unit, wherein each conductive layer is provided with a first conductive portion, a second conductive portion and a third conductive portion. The first conductive portion provides a first potential. The second conductive portion provides a second potential. Each input terminal of the circuit VID unit is electrically connected to the corresponding third conductive portion of each conductive layer. The circuit VID unit outputs a circuit VID according to the potentials of the third conductive portions of the plurality of conductive layers, wherein the circuit VID is determined by the electrical connection between the third conductive portion and the first and second conductive portions of each conductive layer.

### CROSS-REFERENCE TO RELATED APPLICATION

This application claims the priority benefit of Taiwan application serial no. 95134410, filed Sep. 18, 2006. All disclosure of the Taiwan application is incorporated herein by reference.

### BACKGROUND OF THE INVENTION

1. Field of the Invention

The present invention relates to an integrated circuit (IC). More particularly, the present invention relates to an apparatus of expressing circuit version identification (VID).

2. Description of Related Art

With the progress in science and technology, data can be stored in an IC chip instead of a vacuum tube or a transistor used in the earliest stage. The IC chip has a small volume and a large capacity, and therefore is being widely used. Most of the electric appliances have a control switch, and from the simplest current blocking device to the most complicated microcomputer control system, each needs to be controlled by an IC chip.

Nowadays, an application specific integrated circuit (ASIC) is often used in coordination with a corresponding firmware. After the ASIC is revised, the firmware needs to read the circuit version identification (VID) of the ASIC, i.e., the so-called version number. Therefore, the ASIC often has an apparatus of expressing the circuit VID. The firmware reads the circuit VID output by the IC, so as to perform various functions corresponding to the IC of different versions.

Generally, the circuit layout for determining the circuit VID is disposed on the top metal layer (i.e., the third metal layer, referred to as Metal 3 in a process of three metal layers, and taking Metal 3 as an example below). Usually, the mask of the so-called Metal 3 is modified when the ASIC has a new function to be added, a function to be changed or the ASIC has to be revised due to its design errors. Therefore, when the ASIC is revised, the layout of the apparatus of expressing the circuit VID can be modified simultaneously, so as to alter the outputted circuit VID (the version number).

However, to achieve a certain function, both the circuit and the circuit VID of the ASIC are required to be modified, and the circuit to be modified is assumed not to be disposed in Metal 3, at least two masks should be used, thereby increasing the cost. Moreover, the mask of Metal 3 is not employed for the function of the circuit, thus the development cost is increased. However, if the extra cost generated is absorbed by the IC manufacturers themselves, the gross profit of the IC will be reduced; while if the extra cost is reflected on the IC price, the market competitive power of the product will be weakened.

### SUMMARY OF THE INVENTION

Accordingly, the present invention is directed to an apparatus of expressing circuit VID to reduce the number of masks when the IC is revised, to reduce the cost.

The apparatus of expressing the circuit VID disclosed by the present invention comprises a plurality of conductive layers and a circuit VID unit, wherein each of the conductive layers is provided with a first conductive portion, a second conductive portion and a third conductive portion. The first conductive portion provides a first potential, and the second conductive portion provides a second potential. Each input terminal of the circuit VID unit is electrically connected to the corresponding third conductive portion of each conductive layer. The circuit VID unit outputs a circuit VID according to the potentials of the third conductive portions of the plurality of conductive layers, wherein the circuit VID is determined by the electrical connection between the third conductive portion and the first and second conductive portions of each conductive layer.

According to a preferred embodiment of the present invention, the third conductive portion of each conductive layer is partially overlapped with the first and second conductive portions of an adjacent conductive layer. The logic operation may include an add operation, a subtract operation, a binary operation and a thermo code operation.

A method of expressing the circuit VID disclosed by the present invention comprises providing a plurality of conductive layers; disposing a first conductive portion, a second conductive portion and a third conductive portion in each of the conductive layers, wherein the first conductive layer provides a first potential and the second conductive portion provides a second potential; changing the electrical connection between the third conductive portion and the first and second conductive portions of the specific conductive layer when the circuit of a specific conductive layer in the IC needs to be modified; and performing a logic operation on the potentials of the third conductive portions of the plurality of conductive layers to output the circuit VID.

According to a preferred embodiment of the present invention, the aforementioned method further comprises providing a circuit VID unit having a plurality of input terminals, wherein each of the input terminals is electrically connected to the corresponding third conductive portion of each of the conductive layers, so as to perform the logic operation of the present invention to output the circuit VID. The logic operation may include an add operation, a subtract operation, a binary operation and a thermo code operation.

The method of expressing the circuit VID disclosed by the present invention comprises providing a plurality of conductive layers; disposing a first conductive portion, a second conductive portion and a third conductive portion in each of the conductive layers, wherein the first conductive portion provides a first potential and the second conductive portion provides a second potential; changing the electrical connection between the third conductive portion of the specific conductive layer and the first and second conductive portions of an adjacent conductive layer when the circuit of a specific conductive layer in the IC needs to be modified; and performing a logic operation on the potentials of the third conductive portions of the plurality of conductive layers to output the circuit VID.

According to a preferred embodiment of the present invention, the aforementioned method further comprises providing a circuit VID unit having a plurality of input terminals, wherein each of the input terminals is electrically connected to the corresponding third conductive portion of each of the conductive layers, so as to perform the logic operation of the present invention to output the circuit. VID. The logic operation may include an add operation, a subtract operation, a binary operation and a thermo code operation.

In the present invention, each of the conductive layers is provided with a first conductive portion, a second conductive portion and a third conductive layer, and in each of the conductive layers, a connection portion is reserved between the third conductive portion and the first and second conductive portions. Therefore, when a specific mask of the IC needs to be modified to obtain certain functions and the circuit VID thus has to be revised, the connection between the third conductive portion and the first and second conductive portions can be directly modified on the specific mask, thus changing the circuit VID without modifying the masks of other conductive layers.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a circuit block diagram of the apparatus of expressing the circuit VID according to an embodiment of the present invention.

FIGS. 2A, 2B and 2C are structural diagrams of the mask ID units 100 in FIG. 1 on the conductive layers according to an embodiment of the present invention.

FIG. 3 is a flow chart of the method of expressing the circuit VID according to an embodiment of the present invention.

FIGS. 4A, 4B, and 4C are structural diagrams of the mask ID units 100 in FIG. 1 on the conductive layers according to an embodiment of the present invention.

FIG. 5 is a flow chart of the method of expressing the circuit VID according to an embodiment of the present invention.

### DESCRIPTION OF EMBODIMENTS

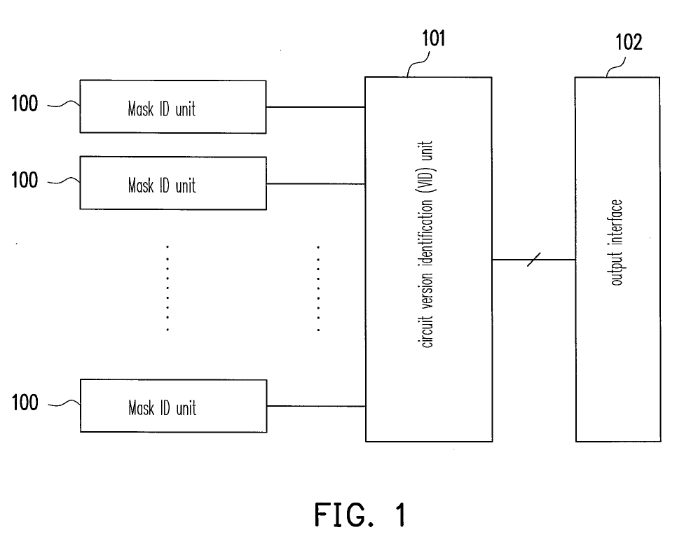

FIG. 1 is a circuit block diagram of the apparatus of expressing the circuit VID according to an embodiment of the present invention. The circuit is used to express the VID of an IC. The circuit includes a plurality of mask ID units 100, a circuit VID unit 101 and an output interface 102. In this embodiment, the plurality of mask ID units 100 is used to represent the number of modifications of each mask due to revision. The circuit VID unit 101 is used to receive the logic states output by the mask ID units 100 and calculating the circuit VID of the IC through logic operation. Additionally, the output interface in this embodiment includes an output pad for connecting the output interface to an external device, so as to output the circuit VID.

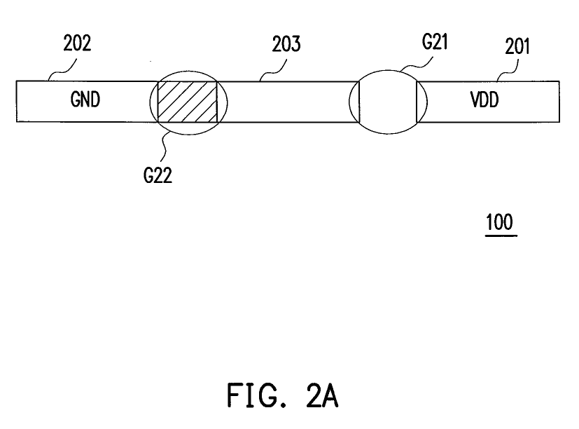

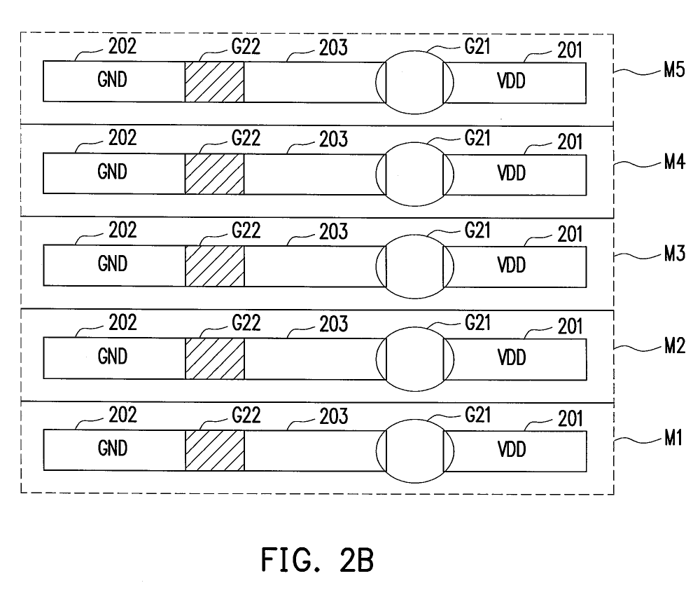

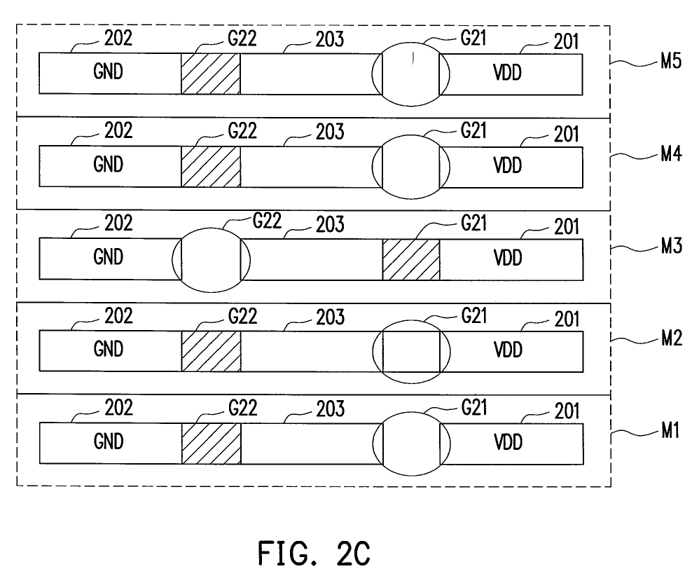

FIGS. 2A and 2B are structural diagrams of the mask ID unit 100 in FIG. 1 on a conductive layer according to an embodiment of the present invention. The mask ID unit 100 in FIG. 2A is used to represent the number of modifications of the mask of the conductive layer due to revision. First, referring to FIG. 2A, the conductive layer in FIG. 2A is provided with a first conductive portion 201, a second conductive portion 202 and a third conductive portion 203. The first conductive portion 201 is used to provide a first potential VDD. The second conductive portion 202 is used to provide a second potential GND. The third conductive portion 203 is electrically connected to an input terminal of the circuit VID unit 101. A reserved gap G21 exists between the first conductive portion 201 and the third conductive portion 203. Similarly, a reserved gap G22 also exists between the second conductive portion 202 and the third conductive portion 203. In this embodiment, in an initial state, the metal layer at the reserved gap G22 is connected. The third conductive portion 203 is electrically connected to the second conductive portion 202 via the metal wires at the reserved gap G22, such that the third conductive portion 203 is at a logic low potential in the initial state.

FIG. 2B is a structural diagram of the mask ID units 100 in FIG. 2A respectively disposed in each of the conductive layers. This embodiment includes five conductive layers, namely, M1-M5, and a dielectric layer is disposed between the conductive layers. The third conductive portion 203 of each conductive layer is electrically connected to the circuit VID unit 101. In this embodiment, in the initial state, all of the third conductive portions 203 are electrically connected to the second conductive portions 202.

In this embodiment, when the mask of the third conductive layer M3 of the IC is modified to obtain a certain function and the circuit VID, the mask of the third conductive layer M3 can be shared to make the third conductive portion 203 and the first conductive portion 201 of the third conductive layer M3 electrically connected through the reserved gap G21, and the electrical connection at the reserved gap G22 between the third conductive portion 203 and the second conductive portion 202 of the third conductive layer M3 is removed, as shown in FIG. 2C. At this point, the third conductive portion 203 of the third conductive layer M3 is at a logic high potential. As the third conductive portion 203 of each conductive layer is electrically connected to each input terminal of the circuit VID unit 101, the circuit VID unit 101 receives the logic states of the third conductive portion 203 to calculate the circuit VID.

According the above embodiment, the mask can be shared to modify the circuit VID. With reference to this embodiment of the present invention, those skilled in the art may derive that a plurality of mask ID units 100 can be disposed in the same conductive layer to deal with the circumstance that, for example, the circuit VID must be altered as the third conductive layer M3 has to be further modified due to some reason.

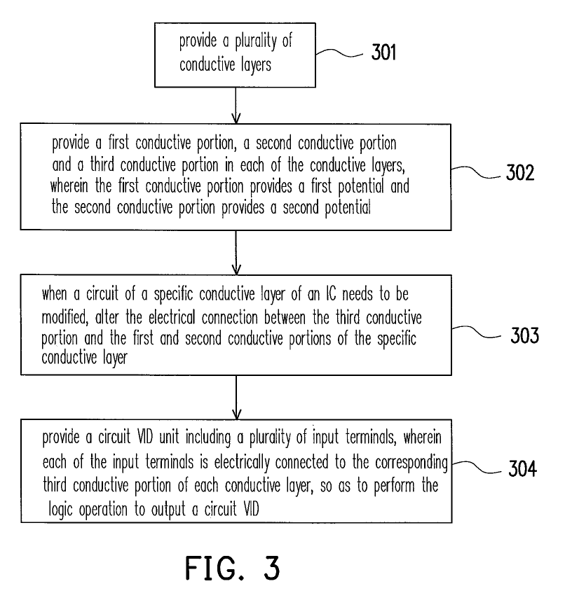

Referring to FIG. 3, first, a plurality of conductive layers is provided (Step 301). Each of the conductive layers is provided with a first conductive portion, a second conductive portion and a third conductive portion, wherein the first conductive portion provides a first potential and the second conductive portion provides a second potential (Step 302). When the circuit of a specific conductive layer in the IC needs to be modified to obtain a certain function, the electrical connection between the third conductive portion and the first and second conductive portions of the specific conductive layer will be altered (Step 303). A circuit VID unit including a plurality of input terminals is provided, wherein each of the input terminals is electrically connected to the corresponding third conductive portion of each conductive layer, so as to perform the logic operation to output the circuit VID (Step 304).

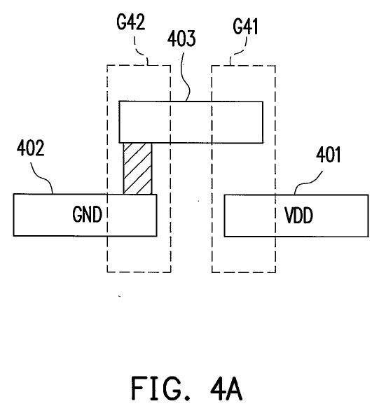

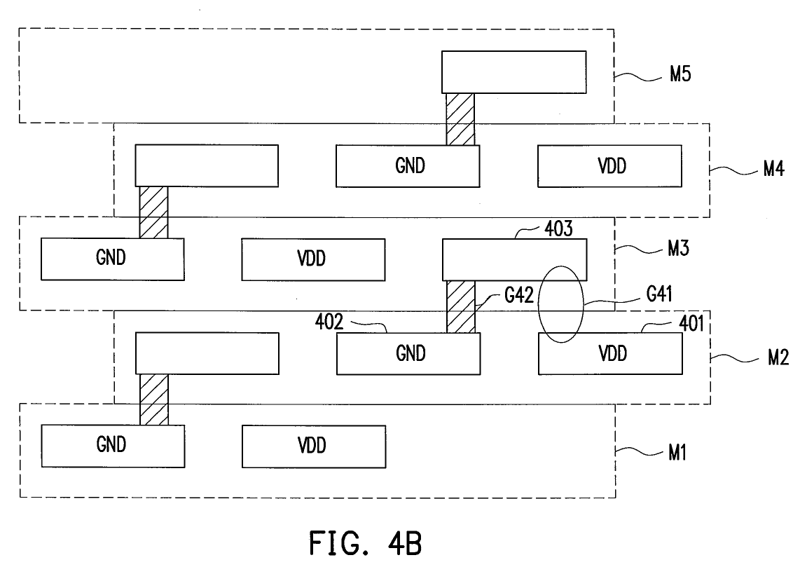

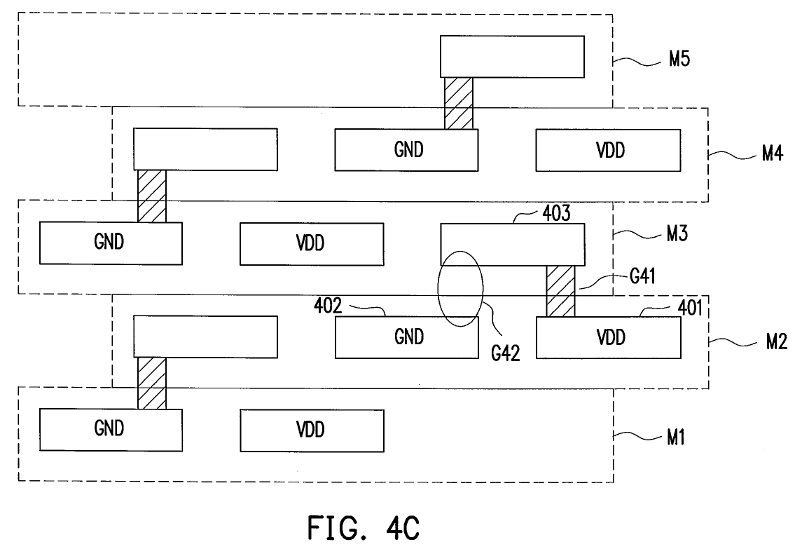

The above embodiment is used to alter the circuit VID when the masks of the conductive layers (metal or polysilicon) are modified. Another embodiment of the present invention is used to alter the circuit VID when the masks of the contact windows between the conductive layers are modified. FIGS. 4A and 4B are structural diagrams of the mask ID units 100 in FIG. 1 on the conductive layers according to an embodiment of the present invention. The mask ID unit 100 in FIG. 2A is used to represent the number of modifications of the mask of the conductive layer due to revision. Referring to FIG. 4A, a conductive layer in FIG. 4A is provided with a third conductive portion 403, and an adjacent conductive layer is provided with a first conductive portion 401 and a second conductive portion 402. The first conductive portion 401 is used to provide a first potential VDD and the second conductive portion 402 is used to provide a second potential GND. The third conductive portion 403 is electrically connected to the input terminal of the circuit VID unit 101. The first conductive portion 401 and the third conductive portion 403 have an overlap section G41. Similarly, the second conductive portion 402 and the third conductive portion 403 also have an overlap section G42. In this embodiment, in the initial state, the third conductive portion 403 is electrically connected to the second conductive portion 402 through the overlap section G42, such that the third conductive portion 403 is at a logic low potential in the initial state.

FIG. 4B is a structural diagram of the mask ID unit 100 in FIG. 4A respectively disposed on each conductive layer. This embodiment also includes five conductive layers, namely M1-M5, and a dielectric layer is disposed between the conductive layers. The third conductive portion 403 of each conductive layer is electrically connected to the circuit VID unit 101. In this embodiment, in the initial state, the third conductive portions 403 of the conductive layers are all electrically connected to the second conductive portions 402.

In this embodiment, the contact window between the third conductive layer M3 and the second conductive layer M2 in the IC is modified to obtain a certain function, such that the mask between the third conductive layer M3 and the second conductive layer M2 has to be modified and thus the circuit VID needs to be altered. Under this circumstance, the mask can be shared to make the third conductive portion 403 of the third conductive layer M3 and the first conductive portion 401 of the second conductive layer M2 electrically connected through the overlap section G41, and to remove the electrical connection at the overlap section G42 between the third conductive portion 403 of the third conductive layer M3 and the second conductive portion 402 of the second conductive layer M2, as shown in FIG. 4C. At this point, the third conductive portion 403 of the third conductive layer M3 is at a logic high potential. As the third conductive portion 403 of each conductive layer is electrically connected to each input terminal of the circuit VID unit 101, the circuit VID unit 101 can receive the logic states of the third conductive portion 403 to calculate the circuit VID.

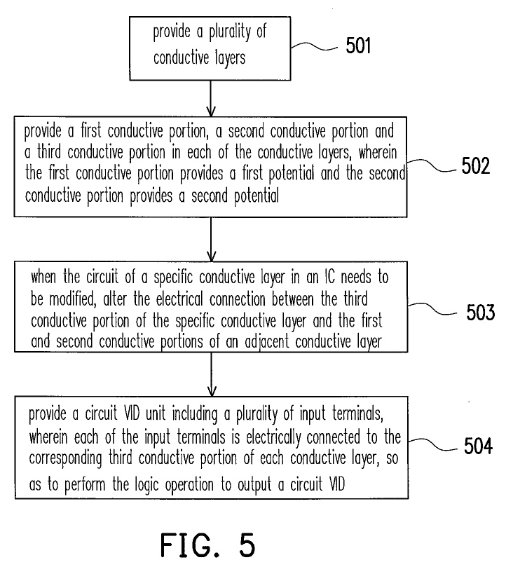

Referring to FIG. 5, first, a plurality of conductive layers is provided (Step 501). Each of the conductive layers is provided with a first conductive portion, a second conductive portion and a third conductive portion, wherein the first conductive portion provides a first potential and the second conductive portion provides a second potential (Step 502). When the circuit of a specific conductive layer in the IC needs to be modified to obtain a certain function, the electrical connection between the third conductive portion of the specific conductive layer and the first and second conductive portions of an adjacent conductive layer will be altered (Step 503). A circuit VID unit including a plurality of input terminals is provided, wherein each input terminal is electrically connected to the corresponding third conductive portion of each conductive layer, so as to perform the logic operation to output the circuit VID (Step 504).

The circuit VID unit 101 in the above embodiment may employ, for example, an add operation, a subtract operation, a binary operation and a thermo code operation. The circuit VID unit 101 may be, for example, a firmware, software or circuit. In addition, the circuit VID unit 101 may be disposed inside or outside the IC.

In view of the above, in the present invention, each of the conductive layers is provided with a first conductive portion, a second conductive portion and a third conductive layer, and in each of the conductive layers, a connection portion is reserved between the third conductive portion and the first and second conductive portions. Therefore, when a specific mask of the IC is modified to obtain certain functions and the circuit VID thus has to be altered, the connection between the third conductive portion and the first and second conductive portions can be directly modified on the specific mask, thus changing the circuit VID without modifying the masks of other conductive layers.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. An apparatus of expressing circuit version identification (VID), used in an integrated circuit (IC), comprising:
a plurality of conductive layers, each provided with a first conductive portion, a second conductive portion and a third conductive portion, wherein the first conductive portion provides a first potential, and the second conductive portion provides a second potential; and
a circuit VID unit, comprising a plurality of input terminals, wherein each input terminal is electrically connected to the corresponding third conductive portion of each conductive layer, so as to perform a logic operation according to the potentials of the third conductive portions of the plurality of conductive layers and then output a circuit VID,
wherein the circuit VID is determined by an electrical connection between the third conductive portion and the first and second conductive portions.

2. The apparatus of expressing circuit VID as claimed in claim 1, wherein the third conductive portion of each conductive layer is partially overlapped with the first and second conductive portions of an adjacent conductive layer.

3. The apparatus of expressing circuit VID as claimed in claim 1, wherein the logic operation includes an add operation, a subtract operation, a binary operation and a thermo code operation.

4. The apparatus of expressing circuit VID as claimed in claim 1, further comprising an output interface for outputting the circuit VID to an external device, wherein the external device is coupled to the IC via the output interface.

5. The apparatus of expressing circuit VID as claimed in claim 4, wherein the output interface comprises an output pad.

6. The apparatus of expressing circuit VID as claimed in claim 1, wherein a dielectric layer is disposed between each of the conductive layers.

7. A method of expressing circuit VID, used in an IC, comprising:
providing a plurality of conductive layers;
disposing a first conductive portion, a second conductive portion and a third conductive portion in each of the conductive layers, wherein the first conductive portion provides a first potential and the second conductive portion provides a second potential;
altering the electrical connection between the third conductive portion and the first and second conductive portions of the specific conductive layer when the circuit of a specific conductive layer in the IC needs to be modified; and
performing a logic operation according to the potentials of the conductive portions of the plurality of conductive layers, and outputting a circuit VID.

8. The method of expressing circuit VID as claimed in claim 7, further comprising:
providing a circuit VID unit comprising a plurality of input terminals, wherein each of the input terminals is electrically connected to the corresponding third conductive portion of each conductive layer, so as to perform the logic operation to output the circuit VID.

9. The method of expressing circuit VID as claimed in claim 8, wherein the logic operation includes an add operation, a subtract operation, a binary operation and a thermo code operation.

10. The method of expressing circuit VID as claimed in claim 7, wherein the step of performing a logic operation according to the potentials of the conductive portions of the plurality of conductive layers and outputting a circuit VID comprises:
outputting the circuit VID via an output interface.

11. The method of expressing circuit VID as claimed in claim 7, wherein a dielectric layer is disposed between each of the conductive layers.

12. A method of expressing circuit VID, used in an IC, comprising:
providing a plurality of conductive layers;
disposing a first conductive portion, a second conductive portion and a third conductive portion in each of the conductive layers, wherein the first conductive portion provides a first potential and the second conductive portion provides a second potential;
altering the electrical connection between the third conductive portion of the specific conductive layer and the first and second conductive portions of an adjacent conductive layer when the circuit of a specific conductive layer in the IC needs to be modified; and
performing a logic operation according to the potentials of the conductive portions of the plurality of conductive layers and outputting a circuit VID.

13. The method of expressing circuit VID as claimed in claim 12, wherein the third conductive portion of each of the conductive layers is partially overlapped with the first and second conductive portions of an adjacent conductive layer.

14. The method of expressing circuit VID as claimed in claim 12, wherein the step of modifying the connection between the third conductive portion of a specific conductive layer and the first and second conductive portions of an adjacent conductive layer comprises:
modifying a contact window between the specific conductive layer and the adjacent conductive layer, so as to alter the connection between the third conductive portion of the specific conductive layer and the first and second conductive portions of the adjacent conductive layer.

15. The method of expressing circuit VID as claimed in claim 12, further comprising:
providing a circuit VID unit comprising a plurality of input terminals, wherein each of the input terminals is electrically connected to the corresponding third conductive portion of each conductive layer, so as to perform the logic operation to output the circuit VID.

16. The method of expressing circuit VID as claimed in claim 12, wherein the logic operation includes an add operation, a subtract operation, a binary operation and a thermo code operation.

17. The method of expressing circuit VID as claimed in claim 12, wherein the step of performing a logic operation according to the potentials of the conductive portions of the plurality of conductive layers and outputting a circuit VID comprises:
outputting the circuit VID via an output interface.

18. The method of expressing circuit VID as claimed in claim 12, wherein a dielectric layer is disposed between each of the conductive layers.
